(19) United States
(12) Patent Application Publication
(10) Pub. No.: US 2026/0330969 A1
(43) Pub. Date: Oct. 22, 2026

(54) SYSTEMS AND METHODS FOR WIRELESS TRAFFIC CONTROL

(71) Applicant: ARDURRA GROUP, INC., Miami, FL (US)

(72) Inventor: Raghu VETURI, Houston, TX (US)

(21) Appl. No.: 19/180,403

(22) Filed: Apr. 16, 2025

(51) Int. Cl. G08G 1/08; G08G 1/01

(52) U.S. Cl. CPC G08G 1/08; G08G 1/012; G08G 1/0125; G08G 1/0145

(57) ABSTRACT

Disclosed is a traffic management system configured to enhance the efficiency of traffic control areas through radio-based communication, replacing traditional detection methods. By leveraging data from radio-equipped devices, such as those found in vehicles and smartphones, the system eliminates the need for in-pavement sensors and cameras. In some implementations, the system gathers data such as vehicle location, speed, and direction from user equipment, which is then filtered and analyzed to provide a comprehensive view of traffic conditions. In some implementations, AI/ML models can be employed to identify patterns and predict future scenarios, enabling near-real-time signal adjustments. In some implementations, the system dynamically manages signal control, implementing algorithm steps to calculate optimal timings and ensure smooth flow across intersections, for example. Interaction with mobile user equipment, including smartphones and in-vehicle systems, provides real-time data for adaptive decision-making. Integration with cloud platforms allows for advanced data analysis and storage.

### FIELD OF THE DISCLOSURE

The present disclosure relates to traffic management systems, specifically to a wireless traffic signal control system that eliminates the need for traditional detection devices in traffic control areas.

### SUMMARY OF THE DISCLOSURE

The disclosure is directed to a traffic management system configured to enhance the efficiency of signalized intersections using radio-based communication. The system replaces traditional traffic detection methods with a more advanced approach that leverages data from radio-equipped vehicles and/or smartphones. The system eliminates the need for in-pavement sensors and cameras, instead relying on gathering real-time data, such as vehicle location, speed, and direction, from user equipment. The data is then filtered and analyzed to provide a comprehensive view of traffic conditions in a traffic control area. In some embodiments, AI models process data to identify patterns and predict future traffic scenarios, enabling the system to make informed decisions about signal adjustments in near-real-time.

In some embodiments, the system is configured to dynamically adjust traffic lights based on the analyzed data. In some embodiments, the system implements algorithmic steps that calculate optimal signal timings, ensuring smooth traffic flow across multiple intersections simultaneously, coordinating signal changes to maintain consistent movement through traffic control areas.

In some embodiments, the system may interact with mobile user equipment, which may include user devices, such as smartphones and/or in-vehicle systems, to provide real-time data that informs the system's decision-making process, allowing the system to adapt to changing traffic conditions, optimizing flow and reducing congestion. In some embodiments, integration with cloud platforms enables advanced data analysis and storage.

The traffic management system described herein offers a modern solution to urban traffic challenges. By utilizing artificial intelligence and/or machine learning (AI/ML) models, and/or radio-based communication, the system provides a more efficient and cost-effective approach to traffic control. The system's ability to process real-time data and adjust signal timings ensures responsive and adaptive management of traffic flow, improving travel times.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an example execution workflow according to some embodiments of the present disclosure;

FIG. 4 illustrates an example AI model execution workflow according to some embodiments of the present disclosure;

FIG. 5 depicts an example implementation of an architecture according to some embodiments of the present disclosure;

FIG. 6 depicts an example implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in some embodiments” as used herein does not necessarily refer to a different embodiment. It is intended, for example, that claimed subject matter include combinations of elements and functionality described in accordance with any embodiments, in whole or in part, described herein.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

As used herein, “can” or “may” or derivations thereof (e.g., the system display can execute instructions X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute an algorithm step according to some embodiments.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided from one or more non-transitory media to one or more processors of one or more computers, integrated circuit (IC), or other programmable data processing apparatus, such that the instructions, which execute via the processor of a computer or other programmable data processing apparatus, implement a functions/acts specified in the block diagrams or operational block or blocks. In some embodiments, the functions/acts noted in the blocks occur out of the order noted in the operational illustrations. For example, two blocks shown in succession can in fact be executed substantially concurrently or the blocks can sometimes be executed in the reverse order, depending upon the functionality/acts involved. Therefore, the order of the blocks describing example implementations of the system are not meant to be limiting.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or server can refer to a networked or clustered complex of processors and associated network and storage devices, which may include one or more computers, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, as found in moving traffic, for example.

In short, a wireless network may include virtually any type of wireless communication mechanism by which signals may be communicated between devices, such as a client device or a computing device, between or within a network, or the like.

A computing device, which may include one or more computers, may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, a global positioning system (GPS) device, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS), or other location-identifying type capability, or a display with a high degree of functionality, such as a touch-sensitive color 2D or 3D display, for example.

Certain embodiments and principles will be discussed in more detail with reference to the figures. According to some embodiments, the disclosed framework provides integrated control and management of one or more devices and/or the applications executing thereon.

By way of a non-limiting example, according to some embodiments, the novel traffic signal control system described herein utilizes radio communication to manage traffic flow at a traffic control area, such as an intersection, for example. The system eliminates the need for traditional detection devices (e.g., in-pavement sensors, cameras, radar/lidar) by using radio signals (e.g., GPS data, cell phone data, from vehicles and smartphones, transmitted via radio signals, in conjunction with a traffic controller, installed at an intersection, to determine the occupancy and flow of traffic. In some embodiments, the traffic controller processes the traffic data and generates traffic control signals to control the flow of traffic while drivers are within the traffic control area. In some embodiments, the system includes existing traditional devices (e.g., in-pavement sensors, cameras, radar/lidar) which the system uses to collect traffic data.

According to some embodiments, the discussion herein may focus on embodiments related to street traffic control; however, these examples should not be construed as limiting, as one of skill in the art would understand that the disclosed framework described herein can apply to various scenarios without departing from the scope of the instant disclosure. For example, the system may be configured to provide collision avoidance for air traffic. In some embodiments, the system can be implemented to avoid collisions in ship harbors, or used to control the flow of foot traffic, as non-limiting examples.

Moreover, embodiments exist where the disclosed framework can be applied to control an autonomous vehicle (e.g., car, boat, plane, drone, etc.) For example, in some embodiments, the traffic control signal includes a vehicle control signal configured to alter the velocity (speed and direction) of a vehicle within a traffic control area.

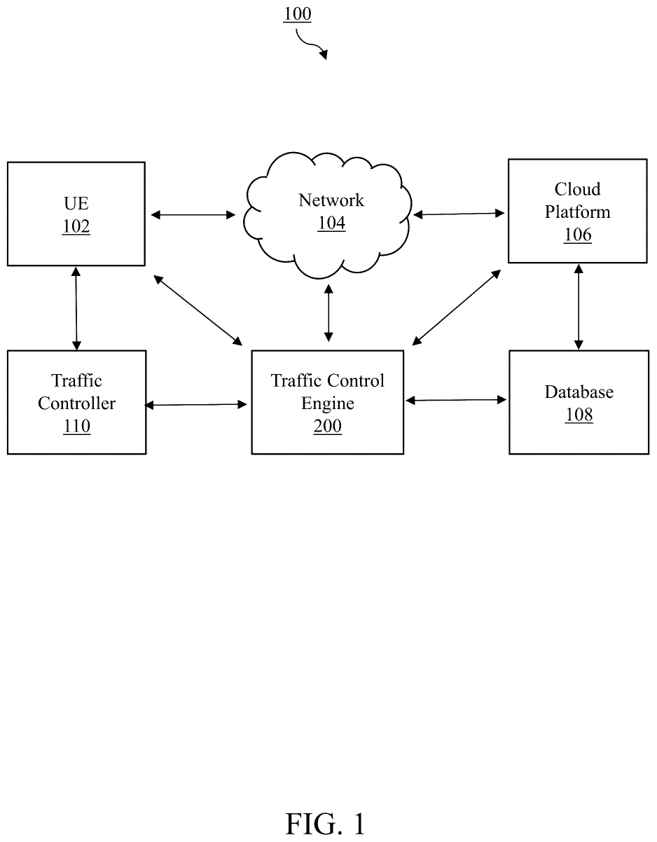

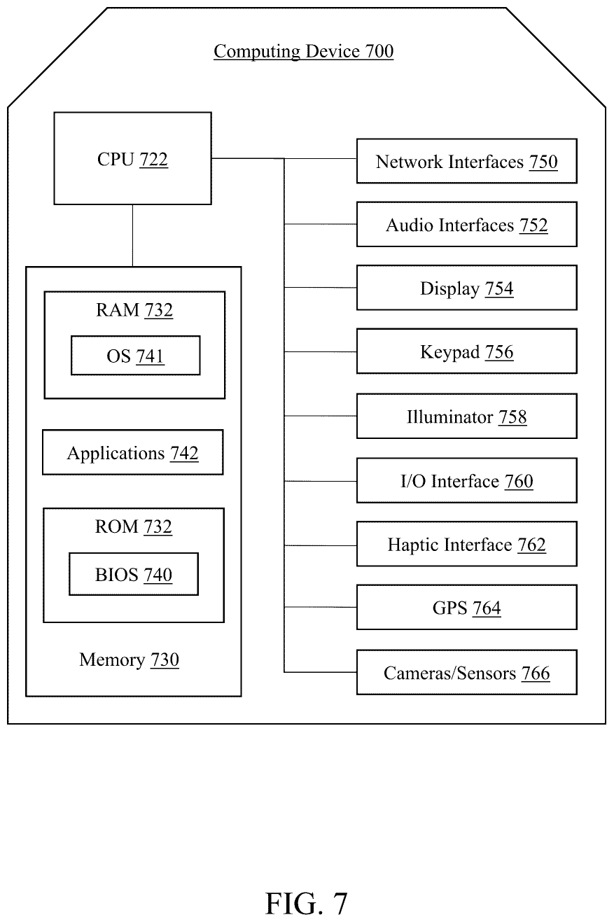

With reference to FIG. 1, system 100 is depicted which includes user equipment (UE) 102 (e.g., a client device, as mentioned above and discussed below in relation to FIG. 7), network 104, cloud platform 106, database 108, traffic controller 110, and/or traffic control engine 200. It should be understood that while system 100 is depicted as including such components, it should not be construed as limiting, as one of ordinary skill in the art would readily understand that varying numbers of UEs, traffic controllers, peripheral devices, cloud platforms, databases and networks can be utilized; however, for purposes of explanation, system 100 is discussed in relation to the example depiction in FIG. 1.

According to some embodiments, UE 102 can be any type of device, such as, but not limited to, a desktop computer, a server, a mobile (smart) phone, tablet, laptop, sensor, IoT device, autonomous machine, appliance, and/or any device equipped with a cellular and/or wireless or wired transceiver. For example, UE 102 can be a smart phone with various Apps installed, which as discussed below in more detail, can enable the identification and/or collection of activity information of the user to guide actual traffic signal control and/or vehicle control while the smart phone is in motion.

According to some embodiments, UE 102 may include one or more components in a vehicle configured to receive, transmit, and process control instructions. UE components can include, but are not limited to, a GPS receiver, a radio transmitter/receiver, an onboard computer, and/or a wireless vehicle-to-infrastructure (V2I) communication platform. For example, in some embodiments, UE 102 includes a GPS receiver that determines the vehicle's precise position by receiving location data from satellites. In some embodiments, UE 102 includes a radio transmitter/receiver within a vehicle configured for communication with the traffic controller and other vehicles using radio signals. In some embodiments, UE 102 includes an onboard computer in a vehicle configured to process incoming data and/or implement control instructions to manage vehicle operations. Furthermore, UE 102 may include a vehicle-to-vehicle (V2V) communication system, allowing UE 102 to exchange information with other user equipment integrated with other vehicles to enhance safety and traffic flow.

Other components of UE 102 might include an inertial measurement unit (IMU) for navigation and control, a CAN bus interface for connecting electronic control units (ECUs), and a human-machine interface (HMI) for displaying information and alerts to the driver. In the case of autonomous vehicles, UE 102 may include an autonomous driving system that processes control instructions to manage navigation and decision-making. Safety and diagnostic systems within UE 102 monitor vehicle health and ensure compliance with control instructions, in some embodiments, while a data logger records data from various sensors and communication systems for analysis and troubleshooting. Any combination of the aforementioned components may form part of a UE 102, through any wired or wireless connection, such as those described above and below.

In some embodiments, one or more peripheral devices (not shown) can be connected to UE 102, and can be any type of peripheral device, such as, but not limited to, a wearable device (e.g., e.g., smart watch), a radio, speaker, sensor, and the like. In some embodiments, peripheral device can be any type of device that is connectable to UE 102 via any type of known or to be known pairing mechanism, including, but not limited to, WiFi, Bluetooth™, Bluetooth Low Energy (BLE), NFC, and the like. For example, the peripheral device can be a device that connectively pairs with UE 102, which includes a user's smart phone, a vehicle's computer system (e.g., GPS system), a radio transceiver, in some non-limiting examples. In some embodiments, traffic controller 110 can be considered a peripheral device in accordance with some embodiments.

In some embodiments, network 104 can be any type of network, such as, but not limited to, a wireless network, cellular network, GPS network, the Internet, and the like (as discussed above). Network 104 facilitates connectivity of the components of system 100, as illustrated in FIG. 1. Network 104 is configured to receive and/or transmit radio signals used by UE 102 and/or traffic controller 110 in some embodiments.

According to some embodiments, cloud platform 106 may be any type of cloud operating platform and/or network-based system upon which applications, operations, and/or other forms of network resources for traffic control may be located. For example, platform 106 may be a service provider and/or network provider from where services and/or applications may be accessed, sourced or executed from. For example, platform 106 can represent the cloud-based architecture associated with a smart home or network provider, which has associated network resources hosted on the internet or private network (e.g., network 104), which enables (via traffic control engine 200) the device control and management discussed herein.

In some embodiments, cloud platform 106 may include a server(s) and/or a database of information which is accessible over network 104. In some embodiments, a database 108 of cloud platform 106 may store a dataset of data and metadata associated with local and/or network information related to a user(s) of the components of system 100 and/or each of the components of system 100 (e.g., UE 102, and/or the services and applications provided by cloud platform 106 and/or traffic control engine 200).

In some embodiments, for example, cloud platform 106 can provide a private/proprietary management platform, whereby traffic control engine 200, discussed infra, corresponds to the novel functionality platform 106 enables, hosts and provides to a network 104 and other devices/platforms operating thereon.

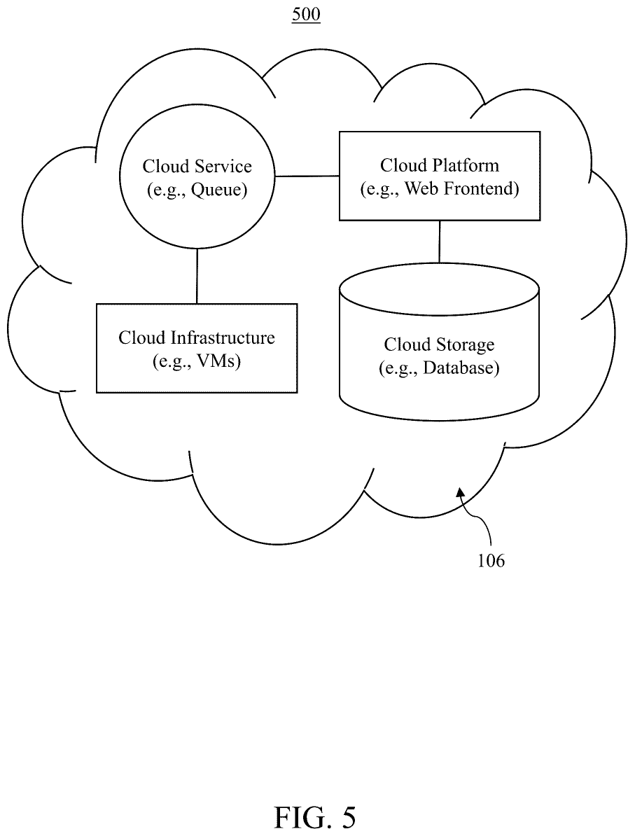

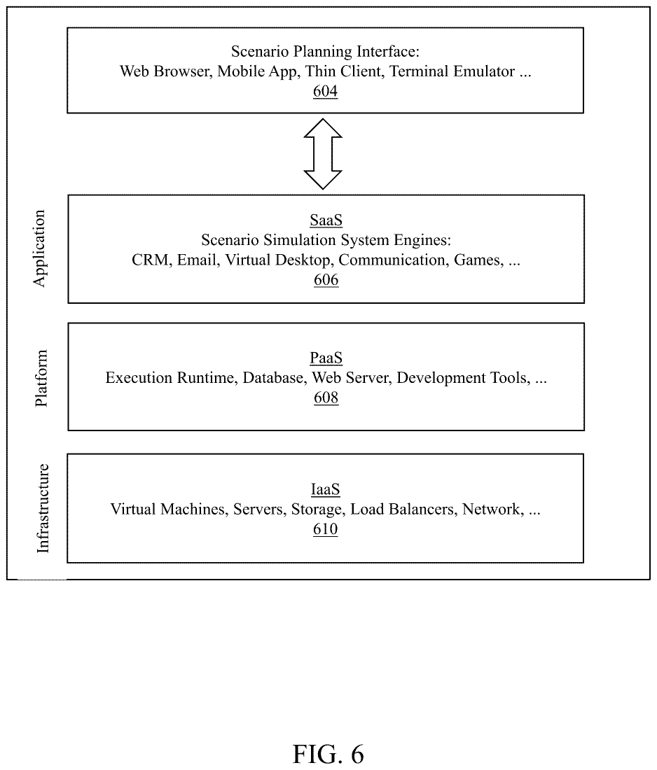

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 120 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud platform 106, as discussed supra) or a plurality of platforms. Database 108 may receive storage instructions/requests from, for example, traffic control engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

In some embodiments, traffic controller 110 may include hardware positioned at a fixed location within a traffic control area (e.g., a radio transceiver attached to a light pole at or near an intersection). In some embodiments, such hardware may include one or more of the features discussed in relation to FIG. 7, such a central processing unit (CPU) for running control algorithms and making real-time decisions. In some embodiments, traffic controller 110 includes communication hardware, such as radio transceivers and network interfaces, which may include at least a portion of network 104, configured for receiving data from one or more UE 102s, connecting to cloud platform 106, and/or communicating with other traffic controllers 110 in various traffic control areas.

In some embodiments, traffic controller 110 includes an edge-computing device configured to process data locally and make real-time decisions without relying solely on centralized cloud resources. In some embodiments, traffic controller 110 includes a compact, powerful computing unit configured to execute complex algorithms and data processing tasks within the traffic control area.

The edge-computing device processes data collected from user equipment 102 and/or other sensors for immediate analysis of vehicle location, speed, and direction data, enabling the traffic controller 110 to dynamically adjust signal timings in response to real-time traffic conditions. By handling data at the edge, the system reduces latency, ensuring faster response times and more efficient traffic management.

In some embodiments, the edge-computing device associated with and/or part of traffic controller 110 can run AI models to predict traffic patterns and optimize signal configurations. In some embodiments, the edge-computing device can also filter and aggregate data before sending the data to the cloud platform 106 for further analysis or storage, reducing the bandwidth required for data transmission. This local processing capability enhances the overall resilience and reliability of the traffic management system allowing the system to continue to function effectively even if connectivity to the cloud is temporarily lost.

It is understood that a traffic control area may include a plurality of traffic controllers 110 configured to coordinate the movement of a plurality of UEs 102, and/or the vehicles associated therewith. Communication interfaces facilitate the exchange of real-time data between one or more traffic controllers 110 and UE 102 devices, enabling the system to respond dynamically to changing traffic conditions using “crowd sourced” traffic data. In some embodiments, where a traffic control area does not include at least one fixed, dedicated hardware for sensing radio signals, the presence of a UE 102 within a traffic control area can be triggered through the UE 102 sending location data and/or routing information (e.g., programmed navigation), to cloud platform 106, which then implements the various traffic control features described herein by sending traffic control signal generated by the cloud platform 106 to traffic control devices (e.g., traffic lights).

In some embodiments, the interaction between fixed traffic controllers 110 and mobile UE 102s, which can include smartphones and in-vehicle systems, includes data being transmitted to the traffic controller 110 from UE 102, and vice versa, allowing the framework to make informed decisions about signal adjustments. This real-time interaction ensures that the traffic management system is adaptive and responsive, capable of adjusting to the ever-changing conditions of urban traffic environments.

Traffic control engine 200, as discussed above and further below in more detail, can include components for the disclosed functionality. According to some embodiments, at least part of traffic control engine 200 may be a special purpose machine or processor and can be hosted by a device on network 104, within cloud platform 106, and/or on UE 102. In some embodiments, at least part of traffic control engine 200 may be hosted by a server and/or set of servers associated with cloud platform 106.

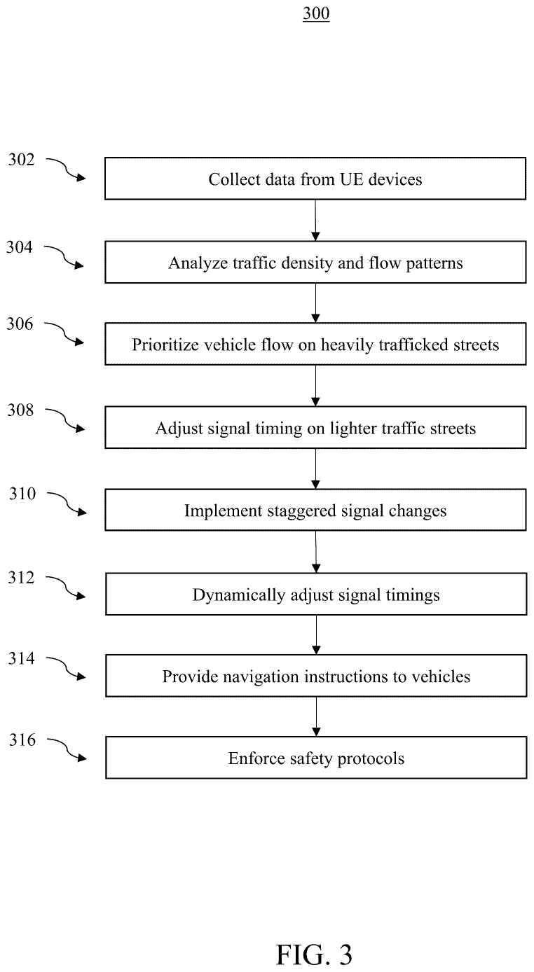

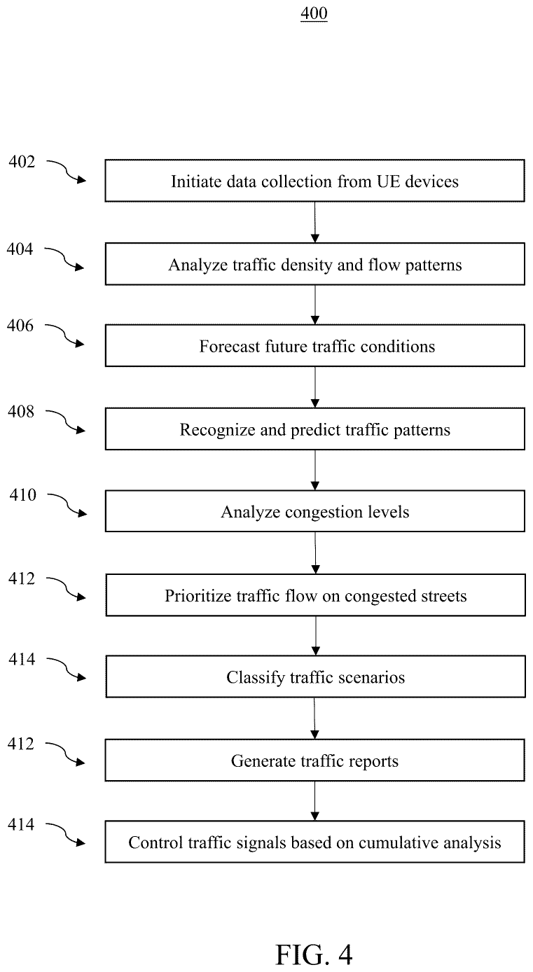

According to some embodiments, as discussed in more detail below, traffic control engine 200 may be configured to implement and/or control a plurality of services and/or microservices, where each of the plurality of services/microservices are configured to execute a plurality of workflows associated with performing the disclosed application control and management framework. Non-limiting embodiments of such workflows are provided below in relation to at least FIGS. 3-4.

According to some embodiments, as discussed above, at least part of traffic control engine 200 may function as an application provided by cloud platform 106. In some embodiments, at least part of traffic control engine 200 may function as an application installed on a server(s), network location and/or other type of network resource associated with platform 106. In some embodiments, at least part of traffic control engine 200 may function as an application installed and/or executing on UE 102. In some embodiments, such application may be a web-based application accessed by UE over network 104 from cloud platform 106. In some embodiments, at least part of traffic control engine 200 may be configured and/or installed as an augmenting script, program, or application (e.g., a plug-in or extension) to another application or program provided by cloud platform 106 and/or executing on UE 102.

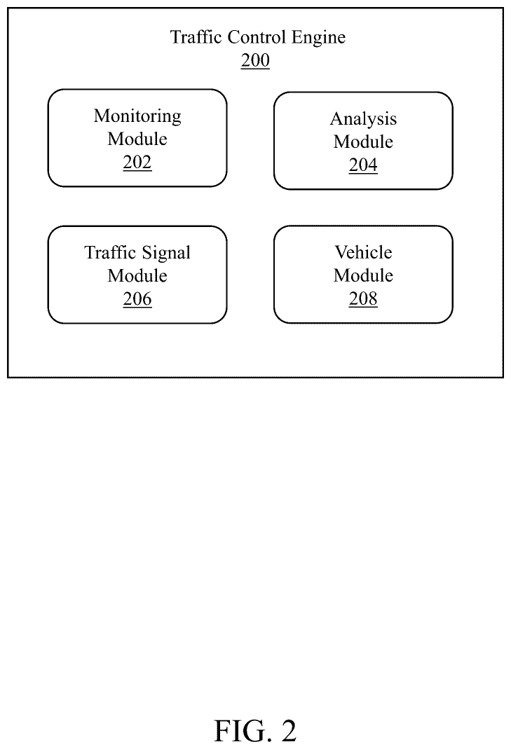

As illustrated in FIG. 2, according to some embodiments, traffic control engine 200 includes a monitoring module 202, an analysis module 204, a traffic signal module 206, and vehicle module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of traffic control engine 200 and each of its modules, and their role within embodiments of the present disclosure will be discussed below.

In some embodiments, the monitoring module 202 is configured to execute computer instructions that enable real-time data acquisition and processing from various sources. In some embodiments, the monitoring module 202 is configured to implement a data collection protocol that interfaces with UE 102 GPS devices and/or radio communication systems, as examples, to gather (vehicle) location, direction, and/or speed data. In some embodiments, the monitoring module 202 is configured to execute data filtering algorithms to ensure the accuracy and relevance of the incoming data, removing any noise or irrelevant information. In some embodiments, the monitoring module 202 is configured to perform data aggregation, compiling individual data points into comprehensive traffic flow metrics. In some embodiments, the monitoring module 202 is configured to execute a substantially real-time (e.g., including delays associated with processing and/or signal transmission) data visualization function that updates traffic conditions on a status dashboard for remote operators. In some embodiments, the traffic monitoring module 202 is configured to execute alert generation instructions to notify operators of any anomalies or critical traffic conditions that require immediate attention.

In some embodiments, the analysis module 204 is configured to execute computer instructions for processing and interpreting traffic data to optimize flow. In some embodiments, the analysis module 204 is configured to execute data processing functions that analyze traffic density and flow patterns. In some embodiments, the analysis module 204 is configured to implement predictive analytics to forecast future traffic conditions and potential congestion points based on historical and real-time data. In some embodiments, the analysis module 204 is configured to an execute optimization function configured to identify the most efficient traffic signal timings and/or configurations. In some embodiments, the analysis module 204 is configured to generate detailed traffic reports and insights for planning and decision-making. In some embodiments, the analysis module 204 is configured to execute a feedback loop function that continuously refines analysis based on new data inputs, ensuring adaptive and responsive traffic management.

In some embodiments, the traffic signal module 206 is configured to execute computer instructions that dynamically adjust traffic signals in response to analyzed data. In some embodiments, the traffic signal module 206 is configured to implement signal timing algorithms configured to calculate optimal signal durations based on current traffic conditions. In some embodiments, the traffic signal module 206 is configured to execute communication protocols to interface with traffic signal hardware (e.g., traffic lights, crosswalk signs, cameras, etc.), ensuring precise implementation of timing adjustments. In some embodiments, the traffic signal module 206 is configured to execute a synchronization function that coordinates signal changes across multiple intersections to maintain smooth traffic flow over a distance with multiple traffic control areas (e.g., intersections, school zones, construction areas, etc.). In some embodiments, the traffic signal module 206 is configured to execute contingency plans in case of system failures or unexpected traffic surges, using conventional traffic monitoring components as a back-up, maintaining safety and efficiency. In some embodiments, the traffic signal module 206 is configured to track the effectiveness of signal adjustments and provides feedback to the analysis module 204 for continuous improvement.

Turning to FIG. 3, Process 300 provides non-limiting example embodiments for the disclosed traffic management system. According to some embodiments, process 300 provides non-limiting embodiments for managing and optimizing traffic flow for which the disclosed framework (e.g., via traffic control engine 200) can control, manage, and manipulate the traffic conditions using a plurality of UE's 102 associated with different vehicles. Steps described in the figures represent both an execution of a computer algorithm and a method of implementing the system, in accordance with some embodiments.

In a non-limiting scenario, a first vehicle is approaching an intersection on a lighter traffic street, while a plurality of evenly spaced vehicles are traveling on a heavier traffic street. In this example, these vehicles are distributed throughout three traffic control areas, all headed toward the third traffic control area, which includes intersections with lights. The first vehicle is approaching the third traffic control area from a different direction and must pass through a fourth traffic control area to get to the third traffic control area.

According to some embodiments, steps 302-304 of process 300 can be performed by monitoring module 202 of traffic control engine 200; steps 306-308 can be performed by analysis module 204; steps 310-312 can be performed by traffic signal module 206; and steps 314-316 can be performed by vehicle module 208.

It should be understood that while the discussion herein will be with reference to a specific example, the example should not be construed as limiting, as any type of traffic scenario can benefit from the traffic optimization techniques provided by the system functionality without departing from the scope of the instant disclosure.

According to some embodiments, process 300 begins with step 302 where traffic control engine 200 gathers real-time location, speed, and direction data from UE 102 devices. As mentioned previously, any program can be executed by UE 102 (e.g., GPS data collection). By way of non-limiting examples, data collection can include any type of known or to be known data acquisition methods such as, but not limited to, cellular networks, GPS tracking, radio communications, and the like, or some combination thereof.

In some embodiments, step 302 can involve removing noise or irrelevant information from the incoming data. In some embodiments, data aggregation is performed by traffic control engine 200 to compile individual data points into comprehensive traffic flow metrics. In some embodiments, real-time data visualization is executed, which can include, but is not limited to, updating traffic conditions on a status dashboard, such as a vehicle navigation screen, a smart phone display, and/or the like, or some combination thereof. In some embodiments, an alert generation can be determined and/or provided, where the traffic control engine 200 is configured to notify operators of anomalies or critical traffic conditions. For example, if a sudden slowdown is detected but traffic flow remains consistent, then no alert is generated in a non-limiting example.

In step 304, traffic control engine 200 can analyze traffic density and flow patterns. In some embodiments, the analysis can involve any type of computational analysis that can enable traffic control engine 200 to derive, determine, extract, retrieve, or otherwise optimize traffic flow. In some embodiments, such computational analysis can involve parsing the usage data, and extracting information indicating times, duration, activity, and the like. In some embodiments, the analysis includes the use of artificial intelligence (AI), discussed further in relation to FIG. 4.

Turning back to FIG. 3, in some embodiments, in step 306, traffic control engine 200 is configured to prioritize the flow of the plurality of vehicles on the heavier traffic street by analyzing the distribution of vehicles across the three traffic control areas. In some embodiments, this includes determining which traffic control areas are most congested and require immediate attention to prevent bottlenecks. In some embodiments, the system can then allocate more green light time to these intersections to facilitate smoother traffic flow.

In step 308, traffic control engine 200 can adjust the signal timing for the first vehicle approaching from the lighter traffic street, in accordance with some embodiments. Some embodiments include calculating the optimal time to change the signal at the intersection in the third traffic control area to allow the first vehicle to pass through with minimal delay, while still maintaining the most efficient flow for the heavier traffic street.

In step 310, traffic control engine 200 can implement a staggered signal change strategy across the three traffic control areas. This involves coordinating the timing of signals so that vehicles on the heavier traffic street can move sequentially through each area without unnecessary stops, reducing congestion and improving travel time.

In step 312, traffic control engine 200 can dynamically adjust the signal timings in response to real-time changes in traffic conditions. This involves continuously monitoring the flow of vehicles and making on-the-fly adjustments to signal timings to accommodate any unexpected changes, such as an increase in traffic volume or an incident that disrupts normal flow.

In step 314, traffic control engine 200 is configured to provide real-time navigation instructions to the first vehicle. For example, traffic control engine 200 may reduce the speed of the vehicle when in the fourth traffic control area, which may include receiving and executing instructions transmitted from the fourth traffic control area. The instructions may cause the vehicle to arrive at the third traffic control area at a time where continuing through the third traffic control area has a minimum or zero wait time. In some embodiments, traffic control engine 200 is configured to control a velocity of a vehicle associated with UE 102 and/or provide turn-by-turn directions and/or speed suggestions to minimize travel time and avoid congested areas.

In step 316, traffic control engine 200 can enforce safety protocols to ensure all vehicles adhere to traffic rules and avoid collisions as they navigate through the intersections. In some embodiments, this involves monitoring UE 102 behavior, which may correlate to the behavior of a vehicle, and issuing alerts or taking corrective actions if any vehicle deviates from expected patterns, ensuring a safe and orderly flow of traffic.

In some embodiments, traffic control engine 200 may be configured to utilize one or more AI techniques chosen from, but not limited to, machine learning, computer vision, feature vector analysis, decision trees, boosting, support-vector machines, neural networks, nearest neighbor algorithms, Naive Bayes, bagging, random forests, logistic regression, and the like. By way of a non-limiting example, traffic control engine 200 can implement an XGBoost algorithm for regression and/or classification to analyze the data from one or more UEs 102, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model for the control framework,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained AI model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained AI model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In the non-limiting example describe herein, machine learning models, such as regression and classification models like XGBoost, are suitable AI models to analyze traffic data and predict flow and congestion levels, aiding in the determination of optimal traffic signal timings, in accordance with some embodiments. In some embodiments, decision trees and/or random forests assist in decision-making processes by identifying intersections that require immediate attention based on traffic density in this non-limiting example. Neural networks, including feedforward and recurrent neural networks, in some embodiments, are utilized for recognizing traffic patterns and predicting future conditions. In some embodiments, convolutional neural networks process visual data from traffic cameras to analyze vehicle movements, which allows the system to use existing infrastructure in conjunction with radio-based traffic control.

In some embodiments, predictive analytics models, such as Bayesian models and support vector machines, can provide probabilistic predictions of traffic conditions and classify different traffic scenarios. In some embodiments, data processing and analysis models, like feature vector analysis and boosting techniques, are configured to extract relevant features from traffic data for further analysis. Anomaly detection models, such as Naive Bayes, can identify unexpected traffic patterns and trigger alerts for operators, in accordance with some embodiments. In some embodiments, one or more of these AI models work within the traffic control engine 200 to ensure efficient, adaptive, and responsive traffic management.

Turning to FIG. 4, Process 400 provides non-limiting example embodiments for the deployment and/or implementation of the disclosed framework.

According to some embodiments, Process 400 begins with Step 402 where traffic control engine 200 receives data from UE 102 devices, which may include real-time location, speed, and direction data, using GPS tracking and radio communication, as a non-limiting example.

In step 404, machine learning models are utilized to analyze traffic density and flow patterns, identifying potential congestion points and optimizing traffic flow.

In some embodiments, step 406 includes implementing predictive analytics configured to forecast future traffic conditions, which may include using historical and real-time data to anticipate congestion and adjust traffic signals.

In step 408, neural networks are deployed which are configured to recognize and predict traffic patterns, enabling adaptive signal timing adjustments based on evolving traffic conditions.

Some embodiments include a step 410 which uses convolutional neural networks to process visual data from traffic cameras, detecting vehicle movements and analyzing congestion levels at intersections.

In some embodiments, in step 412, decision trees are applied to prioritize traffic flow on heavily congested streets, determining which intersections require immediate attention to prevent bottlenecks.

In some embodiments, a step 414 includes executing support vector machines to classify different traffic scenarios, aiding in the decision-making process for signal timing adjustments.

In step 416, the system controls traffic signals based on cumulative data, implementing optimal signal configurations and timings.

FIG. 7 is a schematic diagram illustrating a client device showing an example embodiment of a UE that may be used within the present disclosure and/or the framework illustrated in FIG. 1. Client device 700 may include many more or less components than those shown in FIG. 7, such as a plurality of computers. However, the components shown are sufficient to disclose an illustrative embodiment for implementing the present disclosure. Client device 700 may represent, for example, UE 102 discussed above at least in relation to FIG. 1.

As shown in the figure, in some embodiments, client device 700 includes one or more processors (CPU) 722 in communication with one or more non-transitory computer readable media 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, client device 700 may, through other components, provide other information that may be employed to determine a physical location of the device, including for example, a MAC address, Internet Protocol (IP) address, or the like.

Mass memory 730 includes a RAM 732, a ROM 734, and/or other non-transitory storage means. Mass memory 730 illustrates another example of computer storage media for storage of information such as computer readable instructions, data structures, program modules, usage data, or other data. Mass memory 730 stores a basic input/output system (“BIOS”) 740 for controlling low-level operation of client device 700. The mass memory also stores an operating system 741 for controlling the operation of client device 700.

Memory 730 further includes one or more data stores, which can be utilized by client device 700 to store, among other things, applications 742 for executing transformation engine 200, and/or other information or data. For example, data stores may be employed to store information that describes various capabilities of client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within client device 700.

Applications 742 may include computer executable instructions which, when executed by client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with traffic control engine 200 and its affiliates.

As used herein, the term “engine” identifies at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether some embodiments are implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

One or more aspects of some embodiments may be implemented by representative instructions stored on a machine-readable medium which represents various logic within the processor, which when read by a machine causes the machine to execute logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, the system can be described as comprising one or more computers comprising one or more processors and one or more non-transitory computer readable media. In some embodiments, the one or more non-transitory computer readable media comprising program instructions stored thereon that when executed cause the one or more computers to execute one or more algorithm steps. Some embodiments include a step to collect equipment data from user equipment including a location, a speed, and/or a direction of the user equipment. Some embodiments include a step to execute a traffic analysis of traffic conditions at the location of the user equipment. Some embodiments include a step to execute a traffic control signal configured to minimize a time the user equipment spends in a traffic control area based on the traffic analysis.

In some embodiments, the user equipment is configured to transmit the equipment data over a radio frequency. In some embodiments, the user equipment includes a cellular phone. In some embodiments, the user equipment includes a Wi-Fi transmitter. In some embodiments, the user equipment includes a dedicated short-range communications (DSRC) transmitter. In some embodiments, the user equipment includes a radio frequency identification (RFID) transmitter.

In some embodiments, the equipment data is collected by a fixed radio receiver within the traffic control area. In some embodiments, the fixed radio receiver is configured to communicate with a cloud platform. In some embodiments, the cloud platform is configured to execute one or more artificial intelligence (AI) models for at least a portion of the traffic analysis.

In some embodiments, the one or more AI models are configured to maximize throughput of a plurality of user devices through the traffic control area. In some embodiments, the traffic control signal is configured to change a traffic light. In some embodiments, the traffic control signal is configured to alter a vehicle velocity. In some embodiments, the traffic control signal is configured to alter a plurality of vehicle velocities simultaneously.

In some embodiments, the user equipment is configured to transmit the equipment data over the radio frequency to a cloud platform. In some embodiments, wherein the radio frequency includes a satellite frequency. In some embodiments, the cloud platform is configured to execute at least a portion of the traffic analysis. In some embodiments, the traffic analysis includes data obtained from other user equipment within or headed to the traffic control area. In some embodiments, the cloud platform is configured to control traffic lights in the traffic control area based on the traffic analysis.

For the purposes of this disclosure the term “user”, “subscriber” “provider”, “supplier”, or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session or can refer to an automated software application which receives the data and stores or processes the data. Those skilled in the art will recognize that the methods and systems of the present disclosure may be implemented in many manners and as such are not to be limited by some embodiments and examples. In other words, functional elements being performed by single or multiple components, in various combinations of hardware and software or firmware, and individual functions, may be distributed among software applications at either the client level or server level or both. In this regard, any number of the features of some embodiments described herein may be combined into single or multiple configurations, and some embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, some embodiments of computer implemented methods presented and described as flowcharts in this disclosure are provided by way of non-limiting example in order to provide a more complete understanding of the technology. The disclosed methods are not limited to the operations and logical flow presented herein. Some embodiments are contemplated in which the order of the various operations is altered and in which sub-operations described as being part of a larger operation are performed independently.

While some embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A system comprising:
one or more computers comprising one or more processors and one or more non-transitory computer readable media, the one or more non-transitory computer readable media comprising program instructions stored thereon that when executed cause the one or more computers to:
collect equipment data from user equipment including a location, a speed, and/or a direction of the user equipment;
execute a traffic analysis of traffic conditions at the location of the user equipment; and
execute a traffic control signal configured to minimize a time the user equipment spends in a traffic control area based on the traffic analysis.

2. The system of claim 1, wherein the user equipment is configured to transmit the equipment data over a radio frequency.

3. The system of claim 2, wherein the user equipment includes a cellular phone.

4. The system of claim 2, wherein the user equipment includes a Wi-Fi transmitter.

5. The system of claim 2, wherein the user equipment includes a dedicated short-range communications (DSRC) transmitter.

6. The system of claim 2, wherein the user equipment includes a radio frequency identification (RFID) transmitter.

7. The system of claim 1, wherein the equipment data is collected by a fixed radio receiver within the traffic control area.

8. The system of claim 7, wherein the fixed radio receiver is configured to communicate with a cloud platform.

9. The system of claim 8, wherein the cloud platform is configured to execute one or more AI models for at least a portion of the traffic analysis.

10. The system of claim 9, wherein the one or more artificial intelligence (AI) models are configured to maximize throughput of a plurality of user devices through the traffic control area.

11. The system of claim 1, wherein the traffic control signal is configured to change a traffic light.

12. The system of claim 1, wherein the traffic control signal is configured to alter a vehicle velocity.

13. The system of claim 1, wherein the traffic control signal is configured to alter a plurality of vehicle velocities simultaneously.

14. The system of claim 2, where the user equipment is configured to transmit the equipment data over the radio frequency to a cloud platform.

15. The system of claim 14, wherein the radio frequency includes a satellite frequency.

16. The system of claim 14, wherein the cloud platform is configured to execute at least a portion of the traffic analysis.

17. The system of claim 16, wherein the traffic analysis includes data obtained from other user equipment within or headed to the traffic control area.

18. The system of claim 17, wherein the cloud platform is configured to control traffic lights in the traffic control area based on the traffic analysis.

19. A method comprising:
collecting, by an application, equipment data from user equipment including a location, a speed, and/or a direction of the user equipment;
executing, by the application, a traffic analysis of traffic conditions at the location of the user equipment; and
executing, by the application, a traffic control signal configured to minimize a time the user equipment spends in a traffic control area based on the traffic analysis.

20. The method of claim 19, wherein the traffic control signal is configured to change a traffic light.
